(19) United States
(12) Patent Application Publication
(10) Pub. No.: US 2021/0285076 A1
(43) Pub. Date: Sep. 16, 2021

(54) ALUMINUM-COPPER-MANGANESE-ZIRCONIUM ALLOYS FOR METAL ADDITIVE MANUFACTURING

(71) Applicants: Alexander J. Plotkowski, Knoxville, TN (US); Sumit Bahl, Knoxville, TN (US); Ryan R. Dehoff, Knoxville, TN (US); James A. Haynes, Knoxville, TN (US); Amit Shyam, Knoxville, TN (US); Kevin D. Sisco, Tullahoma, TN (US); Ying Yang, Knoxville, TN (US)

(72) Inventors: Alexander J. Plotkowski, Knoxville, TN (US); Sumit Bahl, Knoxville, TN (US); Ryan R. Dehoff, Knoxville, TN (US); James A. Haynes, Knoxville, TN (US); Amit Shyam, Knoxville, TN (US); Kevin D. Sisco, Tullahoma, TN (US); Ying Yang, Knoxville, TN (US)

(21) Appl. No.: 17/188,952

(22) Filed: Mar. 1, 2021

Related U.S. Application Data
(60) Provisional application No. 62/983,875, filed on Mar. 2, 2020.

(51) Int. Cl. C22C 21/14; B33Y 70/00; B33Y 80/00; C22C 1/04; B33Y 10/00

(52) U.S. Cl. CPC C22C 21/14; B33Y 70/00; B33Y 10/00; C22C 1/0416; B33Y 80/00

(57) ABSTRACT

Aluminum-copper-manganese-zirconium alloys for metal additive manufacturing include 5 wt % to 35 wt % copper, 0.05 wt % to 3 wt % manganese, 0.5 wt % to 5 wt % zirconium, 0 wt % to 3 wt % iron, and 0 wt % to less than 1 wt % silicon, with the balance being aluminum. The as-printed alloys may have a microstructure comprising θ′ intermetallic precipitates having an average diameter of 0.1 μm to 0.3 μm, a microstructure comprising θ intermetallic particles having particle spacing of 50-500 nm with a volume fraction of 0-50%; a microstructure comprising a bimodal distribution of equiaxed grains and columnar grains, or any combination thereof. The as-printed alloys may exhibit superior mechanical properties compared to cast alloys with a similar composition.

### CROSS REFERENCE TO RELATED APPLICATION

This application claims the benefit of the earlier filing date of U.S. Provisional Application No. 62/983,875, filed Mar. 2, 2020, which is incorporated by reference in its entirety herein.

### ACKNOWLEDGMENT OF GOVERNMENT SUPPORT

This invention was made with government support under Contract No. DE-AC05-000R22725 awarded by the U.S. Department of Energy. The government has certain rights in the invention.

### FIELD

Aluminum-copper-manganese-zirconium alloys for metal additive manufacturing are disclosed.

### BACKGROUND

Aluminum alloys are increasingly being used to replace heavier Fe and Ti alloys, due to their high specific strength and good corrosion resistance. Additive manufacturing offers a route to produce complex designs for improved performance and efficiency in a variety of applications, such as within the automotive and aerospace sectors. Unfortunately, only a very small number of Al alloys have been successfully commercialized for additive manufacturing, and the ones that have do not exhibit mechanical properties that are competitive with conventionally processed wrought Al alloys. The reason for the lack of alloys is that most common alloy compositions are highly susceptible to hot tearing (hot cracking, solidification cracking) during solidification processing, including casting, welding, and additive manufacturing. Simultaneously, wrought alloys also show poor thermal stability at elevated temperatures. There exists a need in the art for alloy compostions that are designed to be suited to additive manufacturing methods and that exhibit reduced hot tearing during the conditions used in such methods and/or enhanced thermal stability at elevated temperatures.

### SUMMARY

Embodiments of aluminum-copper-manganese-zirconium alloys for metal additive manufacturing are disclosed. Fabricated objects comprising the alloys, methods of making the fabricated objects, and feedstock powders for use in the methods also are disclosed.

An alloy for additive manufacturing may comprise 5 wt % to 35 wt % copper, 0.05 wt % to 3 wt % manganese, 0.5 wt % to 5 wt % zirconium, 0 wt % to 3 wt % iron, 0 wt % to less than 1 wt % silicon, and aluminum. In some embodiments, the additively manufactured (AM) alloy (i) has an ultimate tensile strength of at least 250 MPa throughout a temperature range of 25° C. to 200° C.; or (ii) has a yield strength of at least 200 MPa throughout a temperature range of 25° C. to 200° C.; or (iii) exhibits an elongation of at least 10% throughout a temperature range of 25° C. to 250° C.; or (iv) exhibits an elongation of at least 20% throughout a temperature range of 200° C. to 300° C.; or (v) any combination of (i), (ii), (iii), and (iv). In some embodiments, the AM alloy comprises (i) a microstructure comprising θ′ intermetallic precipitates having an average diameter of 0.1 μm to 0.3 μm; or (ii) a microstructure comprising θ intermetallic particles having particle spacing of 50 nm to 500 nm with a volume fraction of 0-50%; (iii) a microstructure comprising a bimodal distribution of equiaxed grains and columnar grains having an average length-to-width aspect ratio greater than 3; or (iv) any combination of (i), (ii), and (iii).

An alloy feedstock for additive manufacturing is disclosed and may comprise a powder comprising particles having an average particle size of 10 μm to 150 μm, the particles comprising 5 wt % to 35 wt % copper, 0.05 wt % to 3.0 wt % manganese, 0.5 wt % to 5.0 wt % zirconium, 0 wt % to 3 wt % iron, 0 wt % to less than 1 wt % silicon, and aluminum.

A method for making a fabricated object also is disclosed and may include (a) adding a first amount of an alloy feedstock as disclosed herein to a build platform, (b) exposing the first amount, or a portion thereof, of the alloy feedstock to an energy source to provide a first energy-treated region on the build platform, (c) adding a second amount of the alloy feedstock to the build platform, wherein the second amount of the alloy feedstock is positioned immediately adjacent to the first energy-treated region on the build platform, d) exposing the second amount, or a portion thereof, of the alloy feedstock to the energy source to provide a second energy-treated region on the build platform, and repeating one or more of steps (a), (b), (c), and (d) to fabricate an object.

Embodiments of the disclosed fabricated objects are useful in a wide variety of applications including, but not limited to, automotive and aerospace applications. In some embodiments, the fabricated objects are useful in high temperature applications, such as temperatures up to 400° C.

The foregoing and other objects and features of the present disclosure will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1C are photos of fabricated Al—Cu—Mn—Zr (also referred to herein as “ACMZ”) alloy objects prepared with different processing parameters (FIG. 1A), mechanical test coupons (FIG. 1B), and machining test blocks and automotive pistons (FIG. 1C).

FIGS. 2A and 2B are optical micrographs of test coupons prepared with processing parameters that produced no hot tearing (FIG. 2A) or that did exhibit hot tearing (FIG. 2B).

FIGS. 3A and 3B are a Scheil simulation of the additive ACMZ alloy compared to AA2024 Al—Cu based wrought alloy showing the solidification sequence (FIG. 3A) and the limited solidification interval (FIG. 3B) during the terminal solidification stages.

FIG. 4 are scanning electron microscopy (SEM) images showing representative microstructural variations with respect to the melt pools formed during additive manufacturing of an ACMZ alloy; the magnifications were 500× (upper left), 1000× (upper right), 2500× (lower left), and 5000× (lower right).

FIGS. 5A-5G are SEM images showing a comparison of length scales in cast (FIGS. 5A, 5B) versus additively manufactured (FIGS. 5C-5G) microstructures for Al-9 wt % Cu alloys.

FIG. 6 shows a fast Fourier transformation analysis of the precipitate structure of the embodiment shown by FIG. 5G showing measured lattice spacings (top right) with the body centered tetragonal θ′ precipitate structure (bottom right).

FIGS. 7A-7E are high-resolution scanning tunneling electron microscopy (HR-STEM) images of the additively manufactured alloy at increasing magnifications.

FIG. 8 shows atom probe results for a region of an ACMZ alloy as disclosed herein including θ′ (Al₂Cu) precipitates within the aluminum matrix; the distributions of Cu, Si, Mn, and Zr are shown.

FIG. 9 provides several SEM images showing examples of microstructural variation as a function of location relative to the melt pool boundary, as well as high magnification SEM images showing the existence of θ′ precipitates in the FCC Al matrix, which precipitated in situ during processing.

FIG. 10 is an electron back-scatter diffusion (EBSD) grain map for a cast ACMZ alloy with 9 wt % Cu.

FIG. 11 is an EBSD grain map for an additively manufactured ACMZ alloy with 9 wt % Cu.

FIGS. 12A-12C are graphs comparing the yield strength (FIG. 12A), ultimate tensile strength (FIG. 12B) and percent elongation (FIG. 12C) as a function of temperature of an additively manufactured ACMZ alloy as disclosed herein compared to commercialized additively manufactured aluminum alloys.

FIGS. 13A and 13B show tensile curves of cast and additively manufactured ACMZ alloys as disclosed herein under ambient conditions (FIG. 13A) and a graphical summary of tensile properties for the alloys up to 300° C. (FIG. 13B).

FIGS. 14A and 14B show the effects of aging at various temperatures on Vickers hardness of an additively manufactured ACMZ alloy as printed (FIG. 14A) and as-aged for 5 hours at 240° C. (FIG. 14B).

### DETAILED DESCRIPTION

Embodiments of aluminum-copper-manganese-zirconium (ACMZ) alloys for additive manufacturing are disclosed. The alloys include from 0.5 wt % to 5 wt % zirconium. The resulting microstructural features that resulted from additive manufacturing (AM) were significantly refined compared to corresponding cast alloys including similar copper amounts. In some embodiments, the AM ACMZ alloys exhibited enhanced properties, such as ultimate tensile strength, yield strength, and/or ductility, compared to the cast alloy. The enhanced strength may be attributed to the microstructure, which includes a combination of fine equiaxed and columnar grains, along with in situ formation of θ′ precipitates. The refinement of brittle intermetallics and a bimodal grain size distribution may also contribute to improved tensile elongation in embodiments of the AM alloy embodiments disclosed herein.

### I. OVERVIEW OF TERMS

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Although the steps of some of the disclosed methods are described in a particular, sequential order for convenient presentation, it should be understood that this manner of description encompasses rearrangement, unless a particular ordering is required by specific language set forth below. For example, steps described sequentially may in some cases be rearranged or performed concurrently. Additionally, the description sometimes uses terms like “produce” and “provide” to describe the disclosed methods. These terms are high-level abstractions of the actual steps that are performed. The actual steps that correspond to these terms will vary depending on the particular implementation and are readily discernible by one of ordinary skill in the art.

Unless explained otherwise, all technical and scientific terms used herein have the same meaning as commonly understood to one of ordinary skill in the art to which this disclosure belongs. Although methods and compounds similar or equivalent to those described herein can be used in the practice or testing of the present disclosure, suitable methods and compounds are described below. The compounds, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

To facilitate review of the various embodiments of the disclosure, the following explanations of specific terms and abbreviations are provided:

ACMZ: Aluminum-copper-manganese-zirconium.

Additive Manufacturing (AM): As used herein, additive manufacturing is a process whereby three-dimensional objects are fabricated by adding layer-upon-layer of an alloy feedstock and using an energy source (e.g., a laser, electron beam, thermal print head, or other energy source) to melt and fuse each layer of the alloy feedstock together to form the object. Additive manufacturing an alloy is a process that is distinct from casting an alloy.

Alloy: A metal made by melting and mixing two or more different metals. For example, an aluminum alloy is a metal made by combining aluminum and at least one other metal. In some instances, an alloy is a solid solution of metal elements. In particular embodiments of the present disclosure, the alloy is a quaternary alloy and comprises three alloying elements in addition to aluminum; the quaternary alloy may include minor levels of impurities.

Aluminum Matrix: The primary aluminum phase in an alloy embodiment, such as the alloy phase having aluminum atoms arranged in a face-centered cubic structure, optionally with other elements in solution in the aluminum structure.

Aspect Ratio: As used herein, “aspect ratio” refers to the ratio between length and width of a crystal or grain within an alloy, or to the ratio between diameter and thickness of a θ′ precipitate. For example, a grain with a length of 3 μm and an average width of 1 μm has an aspect ratio of 3. Similarly, a θ′ precipitate with an average diameter of 0.3 μm (300 nm) and an average thickness of 10 nm would have an aspect ratio of 30.

Bimodal Distribution: A distribution with two clear peaks around which data points cluster. As used herein, the term “bimodal distribution” refers to a plurality of grains exhibiting two distinct morphologies.

Columnar Grains: Grains that have a length-to-width aspect ratio ≥2.

Consists essentially of: The phrase “consists essentially of” means that the alloys do not comprise, or are free of, additional components that affect one or more physical characteristics (i.e., change a numerical value of the physical characteristic by more than 5% relative to the value in the absence of the impurity or component), such as the microstructural stability and/or strength of the alloy composition or components formed from the alloy composition by additive manufacturing. Such embodiments consisting essentially of the above-mentioned components can, however, include impurities and other components that do not materially affect the physical characteristics of the alloy composition; however, those impurities and other components that do markedly alter the physical characteristics, such as the microstructural stability, strength, and/or other properties that affect performance at high temperatures, are excluded.

Equiaxed Grains: Grains that have axes of approximately the same length, e.g., rounded or hexagonal grains.

Eutectic Structure/Composition: A homogeneous solid structure formed when multiple solid phases grow together in a cooperative manner from a liquid or molten material. For binary materials, a super lattice is formed having a unique molar ratio between the two alloying elements. At this molar ratio, the mixtures melt as a whole at a specific temperature—the eutectic temperature. At other molar ratios for the binary material, one component of the mixture will melt at a first temperature and the other component(s) will melt at a different (e.g., higher) temperature.

Fabricated Object: An object (e.g., a component or a layer) formed during an additive manufacturing process, wherein a feedstock (e.g., a feedstock powder) is exposed to an energy source to form a shape (e.g., a consolidated pre-defined shape). Any particular shape is contemplated herein, but when the object is “fabricated,” the object is intended to be different (e.g., in terms of exhibited properties, or in terms of form, and/or intermetallic composition) from the feedstock (or feedstock powder) used to prepare the fabricated object.

Feedstock (or Feedstock Powder): In some embodiments, this term refers to an alloy composition as described herein that is used to form a layer of a fabricated object made using the AM methods described herein. In some embodiments, the alloying metals or metal precursors are pre-mixed and/or provided by an atomized alloy ingot. In some particular embodiments, the feedstock is a powder, with powder particles comprising the alloy composition. In an independent embodiment, this term can refer to the starting materials (e.g., individual metals or metal precursors that are not pre-mixed and/or provided by alloy atomized ingots) that are used to form a layer of a fabricated object made using the AM methods described herein.

Hot Tearing: A type of alloy defect that involves forming an irreversible failure (or crack) in the alloy as the hot alloy cools. Hot tearing may produce cracks on the surface or inside the alloy. Often a main tear and numerous smaller branching tears following intergranular paths are present in a fabricated object that exhibits hot tearing.

Immediately Adjacent: When used in reference to the position of one or more layers provided and/or made during an additive manufacturing process used to make fabricated objects of the present disclosure, this term refers to a physical orientation (or ordering) of the reference layer and another layer wherein the reference layer and the other layer are in direct physical contact (e.g., the reference layer is positioned on top of, on the bottom of, or to the immediate left/right of the other layer).

Intermetallic Phase: A solid-state compound present in a fabricated object comprising an alloy embodiment of the present disclosure. In some embodiments, the intermetallic phase contains two or more metallic elements and can exhibit metallic bonding, defined stoichiometry, and/or an ordered crystal structure, optionally with one or more non-metallic elements. In some instances, a fabricated object comprising an alloy of the present disclosure may include regions of a single metal (e.g., Al) and regions of an intermetallic phase (e.g., a binary intermetallic phase like Al₂Cu or Al₃Zr, and/or one or more additional binary, quaternary, and/or single-element intermetallic phases).

Melt Pool (or Melt Region): As used herein, the terms “melt region” or “melt pool” refer to a region of a fabricated object (or intermediate form thereof) that has been melted (e.g., by exposure to a laser or induction melting) and re-solidified.

Microstructure: The fine structure of an alloy (e.g., grains, cells, dendrites, rods, laths, platelets, precipitates, etc.) that can be visualized and examined with a microscope at a magnification of at least 25×. Microstructure can also include nanostructure (e.g., a structure that can be visualized and examined with more powerful tools, such as electron microscopy, transmission electron microscopy, atomic force microscopy, X-ray computed tomography, etc.).

Minor Alloying Elements: Elements added intentionally to modify the properties of an alloy. Exemplary minor alloying elements can include silicon, iron, scandium, vanadium, titanium, erbium, or combinations thereof. If silicon and/or iron, are present as minor alloying elements, they can be included in amounts ranging from 0 to 2 wt %, such as greater than 0 to 1 wt % or greater than 0 to 0.5 wt %. In embodiments comprising scandium, vanadium, titanium, and/or erbium, each such minor alloying element is present, individually, in an amount ranging from 0 to 1% or less, such as greater than 0 to 0.1% or less.

Molten: As used herein, a metal is “molten” when the metal has been converted to a liquid form by heating. In some embodiments, the entire amount of metal present may be converted to a liquid or only a portion of the amount of metal present may be converted to liquid (wherein a portion comprises greater than 0% and less than 100% [wt % or vol %] of the amount of metal, such as 90%, 85%, 80%, 70%, 60%, 50%, 40%, 30%, 20%, 10%, 5%, and the like.

Platelet: A thin layer or plate-like structure that can be present in a fabricated object comprising an alloy embodiment according to the present disclosure.

Rare earth element: As defined by IUPAC and as used herein, the term rare earth element includes the 15 lanthanide elements, scandium, and yttrium —Sc, Y, La, Ce, Pr, Nd, Sm, Eu, Gd, Tb, Dy, Ho, Er, Tm, Yb, or Lu.

Trace Impurities: Elements that may be found in an alloy embodiment at low levels due to contamination resulting from processing (e.g., from manufacturing materials and/or equipment) and/or present in starting materials used to make an alloy embodiment.

Vickers Hardness: A hardness measurement determined by indenting a test material with a pyramidal indenter, particular to Vickers hardness testing units, that is subjected to a load of 50 to 5000 gf for a period of time and measuring the resulting indent size. Vickers hardness may be expressed in units of HV or in units of kg/mm². In particular disclosed embodiments, the Vickers hardness can be measured by as measured by ASTM method E384.

Yield Strength (or Yield Stress): The stress a material can withstand without permanent deformation; the stress at which a material begins to deform plastically.

### II. ALLOYS AND FABRICATED OBJECTS

Embodiments of Al—Cu—Mn—Zr (ACMZ) alloys for additive manufacturing, alloy feedstocks for additive manufacturing, and fabricated objects made from the ACMZ alloys are disclosed. The additively manufactured (AM) alloys include higher amounts of zirconium than is generally found in ACMZ alloys, such as cast ACMZ alloys.

The ACMZ alloy may comprise greater than 0 wt % to 35 wt % copper, 0.05 wt % to 3 wt % manganese, 0.5 wt % to 5 wt % zirconium, 0 wt % to 3 wt % iron, and <1 wt % silicon, with the balance being aluminum. In some embodiments, the ACMZ alloy comprises, consists essentially of, or consists of, 0 wt % to 35 wt % copper, 0.05 wt % to 3 wt % manganese, 0.5 wt % to 5 wt % zirconium, 0 wt % to 3 wt % iron, and <1 wt % silicon, with the balance being aluminum. In certain embodiments, the alloy comprises, consists essentially of, or consists of 5 wt % to 20 wt % copper, 0.05 wt % to 3 wt % manganese, 0.5 wt % to 5 wt % zirconium, 0 wt % to 3 wt % iron, and 0 wt % to less than 1 wt % silicon, with the balance being aluminum. “Consists essentially of” means that the alloys do not comprise, or are free of, additional components that affect one or more physical characteristics (i.e., change a numerical value of the physical characteristic by more than 5% relative to the value in the absence of the impurity or component), such as the microstructural stability and/or strength of the cast alloy composition or the hot tearing susceptibility obtained from this combination of components. Such embodiments consisting essentially of the above-mentioned components can, however, include impurities and other components that do not materially affect the physical characteristics of the alloy composition; however, those impurities and other components that do markedly alter the physical characteristics, such as the microstructural stability, strength, hot tearing, and/or other properties that affect performance at high temperatures, are excluded.

The amount of each component that can be used in certain embodiments of the disclosed ACMZ alloy compositions is described. In any of the foregoing or following embodiments, the amount of copper present in the alloys can range from 0 wt % to 35 wt % or 5 wt % to 35 wt %, such as 0 wt % to 30 wt %, 0 wt % to 25 wt %, 5 wt % to 25 wt %, 5 wt % to 20 wt %, 8 wt % to 20 wt %, 8 wt % to 18 wt %, 8 wt % to 15 wt %, 8 wt % to 12 wt %, 8 wt % to 11 wt %, 8 wt % to 10 wt %, 8.5 wt % to 9.5 wt %. In particular disclosed embodiments, the amount of copper present in the aluminum alloy composition can be selected from 5 wt %, 6 wt %, 7 wt %, 8 wt %, 8.5 wt %, 9 wt %, 9.5 wt % 10 wt %, 10.5 wt %, 11 wt %, 11.5 wt %, 12 wt %, 13 wt %, 14 wt %, 15 wt %, 16 wt %, 17 wt %, 18 wt %, 19 wt %, or 20 wt %.

In any of the foregoing or following embodiments, the amount of manganese present in the alloys can range from 0.05 wt % to 1 wt %, such as 0.1 wt % to 0.8 wt %, 0.2 wt % to 0.75 wt %, 0.2 wt % to 0.7 wt %, 0.3 wt % to 0.6 wt %, 0.35 wt % to 0.55 wt %, or 0.4 wt % to 0.5 wt %. In particular disclosed embodiments, the amount of manganese present in the alloys can be selected from 0.1 wt %, 0.2 wt %, 0.3 wt %, 0.35 wt %, 0.4 wt %, 0.45 wt %, 0.5 wt %, 0.55 wt %, 0.6 wt %, or 0.7 wt %.

In any of the foregoing or following embodiments, the amount of zirconium present in the alloys can range from 0.5 wt % to 6 wt %, such as greater than 0.5 wt % to 5 wt %, 0.5 wt % to 5 wt %, greater than 0.5 wt % to 5 wt %, 0.5 wt % to 4 wt %, greater than 0.5 wt % to 4 wt %, 0.5 wt % to 3 wt %, greater than 0.5 wt % to 3 wt %, 0.5 wt % to 2.5 wt %, greater than 0.5 wt % to 2.5 wt %, 0.5 wt % to 2 wt %, greater than 0.5 wt % to 2 wt %, 0.55 wt % to 2 wt %, 0.6 wt % to 2 wt %, 0.7 wt % to 2 wt %, 0.7 wt % to 1.8 wt %, 0.7 wt % to 1.6 wt %, or 0.7 wt % to 1.5 wt %. In particular disclosed embodiments, the amount of zirconium present in the alloys can be selected from 0.5 wt %, 0.6 wt %, 0.7 wt %, 0.8 wt %, 0.9 wt % 1 wt %, 1.1 wt %, 1.2 wt %, 1.3 wt %, 1.4 wt %, 1.5 wt %, 1.6 wt %, 1.7 wt %, 1.8 wt %, 1.9 wt %, or 2 wt %.

In any of the foregoing or following embodiments, the amount of iron present in the alloys can range from 0 wt % to less than 3 wt %, such as 0 wt % to 2 wt %, 0 wt % to 1 wt %, 0 wt % to 0.5 wt %, 0 wt % to 0.2 wt %, 0 wt % to 0.1 wt % or 0 wt % to less than 0.1 wt %. In particular disclosed embodiments, the amount of iron present in the alloys can be selected from 0 wt %, 0.02 wt %, 0.05 wt %, 0.06 wt %, 0.07 wt %, 0.08 wt %, or 0.09 wt %. Iron typically is maintained below a level of 0.2 wt % to avoid forming intermetallics, which can have a detrimental effect on the hot tearing resistance of the disclosed alloys. In particular disclosed embodiments, the amount of iron included in the alloy is kept to a minimum, with certain embodiments having amounts of iron lower than 0.2 wt %, such as less than 0.15 wt %, or less than 0.1 wt %.

In any of the foregoing or following embodiments, the amount of silicon present in the alloys can range from 0 wt % to less than 1 wt %, such as 0 wt % to 0.7 wt %, 0 wt % to 0.5 wt %, 0 wt % to 0.2 wt %, 0 wt % to 0.1 wt % or 0 wt % to less than 0.1 wt %. In particular disclosed embodiments, the amount of iron present in the alloys can be selected from 0 wt %, 0.02 wt %, 0.05 wt %, 0.06 wt %, 0.07 wt %, 0.08 wt %, or 0.09 wt %. In particular disclosed embodiments, the amount of silicon included in the alloy is kept to a minimum, with certain embodiments having amounts of silicon lower than 0.2 wt %, such as less than 0.1 wt %, or less than 0.08 wt % or less than 0.06 wt %. The amount of silicon present in the alloys is typically minimized so as to avoid poisoning the precipitate-matrix interface.

In any of the foregoing or following embodiments, the alloy may further include trace elements or impurities including, but not limited to, magnesium (Mg), nickel (Ni), cobalt (Co), antimony (Sb), tin (Sn), vanadium (V), rare earth elements, and combinations thereof. Any trace elements, individually or together, may be present in an amount of from 0 wt % to 0.5 wt %, such as 0 wt % to 0.2 wt %, 0 wt % to 0.15 wt %, 0 wt % to 0.1 wt %, 0 wt % to 0.05 wt %, 0 wt % to 0.02 wt %, 0 wt % to 0.01 wt %, or 0 wt % to 0.005 wt %. In particular embodiments, the amount of tin is less than 0.2 wt %, such as less than 0.1 wt %, and/or the amount of vanadium is less than 0.1 wt %, such as 0 wt %.

The amount of aluminum present in the alloys is the balance (or remainder) wt % needed to achieve 100 wt % with other components, and in such embodiments, there may be unavoidable impurities present in the alloy, wherein the total content of impurities amounts to no more than 0.2 wt %, such as 0 wt % to 0.15 wt %, 0 wt % to 0.1 wt %, or 0 wt % to 0.05 wt %. In particular disclosed embodiments, the amount of aluminum present in the alloy can range from 73 wt % to 99.45 wt %, such as 73 wt % to 94.45 wt %, 75 wt % to 94.45 wt %, 75 wt % to 94 wt %, 75 wt % to 93 wt %, 77 wt % to 93 wt %, 80 wt % to 93 wt %, 82 wt % to 93 wt %, 83 wt % to 92 wt %, 84 wt % to 92 wt %, 85 wt % to 92 wt %, 85 wt % to 91.1 wt %, or 85 wt % to 91 wt %, 86 wt % to 90.5 wt %, 86.5 wt % to 90 wt %, or 87 wt % to 90 wt %.

In some embodiments, the alloy comprises 8 wt % to 15 wt % copper, 0.3 wt % to 0.6 wt % manganese, and 0.55 wt % to 2 wt % zirconium. In particular embodiments, the alloy comprises 8 wt % to 12 wt % copper, 0.4 wt % to 0.5 wt % manganese, and 0.7 wt % to 1.5 wt % zirconium.

In one implementation, the alloy comprises, consists essentially of, or consists of, 8 wt % to 15 wt % copper, 0.3 wt % to 0.6 wt % manganese, 0.7 wt % to 1.5 wt % zirconium, 0 wt % to less than 0.1 wt % iron, and 0 wt % to less than 0.1 wt % silicon, with the balance being aluminum. In another implementation, the alloy comprises, consists essentially of, or consists of, 8 wt % to 15 wt % copper, 0.4 wt % to 0.5 wt % manganese, 0.55 wt % to 2 wt % zirconium, 0 wt % to less than 0.1 wt % iron, and 0 wt % to less than 0.1 wt % silicon, with the balance being aluminum. In yet another implementation, the alloy comprises, consists essentially of, or consists of, 8 wt % to 12 wt % copper, 0.4 wt % to 0.5 wt % manganese, 0.8 wt % to 1.2 wt % zirconium, 0 wt % to less than 0.1 wt % iron, and 0 wt % to less than 0.1 wt % silicon, with the balance being aluminum. In still another implementation, the alloy comprises, consists essentially of, or consists of, 8 wt % to 12 wt % copper, 0.4 wt % to 0.5 wt % manganese, 0.8 wt % to 1.0 wt % zirconium, 0 wt % to less than 0.1 wt % iron, and 0 wt % to less than 0.1 wt % silicon, with the balance being aluminum. In another implementation, the alloy comprises, consists essentially of, or consists of, 8 wt % to 10 wt % copper, 0.4 wt % to 0.5 wt % manganese, 0.8 wt % to 1.2 wt % zirconium, 0 wt % to less than 0.1 wt % iron, and 0 wt % to less than 0.1 wt % silicon, with the balance being aluminum. In yet another implementation, the alloy comprises, consists essentially of, or consists of, 8 wt % to 10 wt % copper, 0.4 wt % to 0.5 wt % manganese, 0.8 wt % to 1.0 wt % zirconium, 0 wt % to less than 0.1 wt % iron, and 0 wt % to less than 0.1 wt % silicon, with the balance being aluminum.

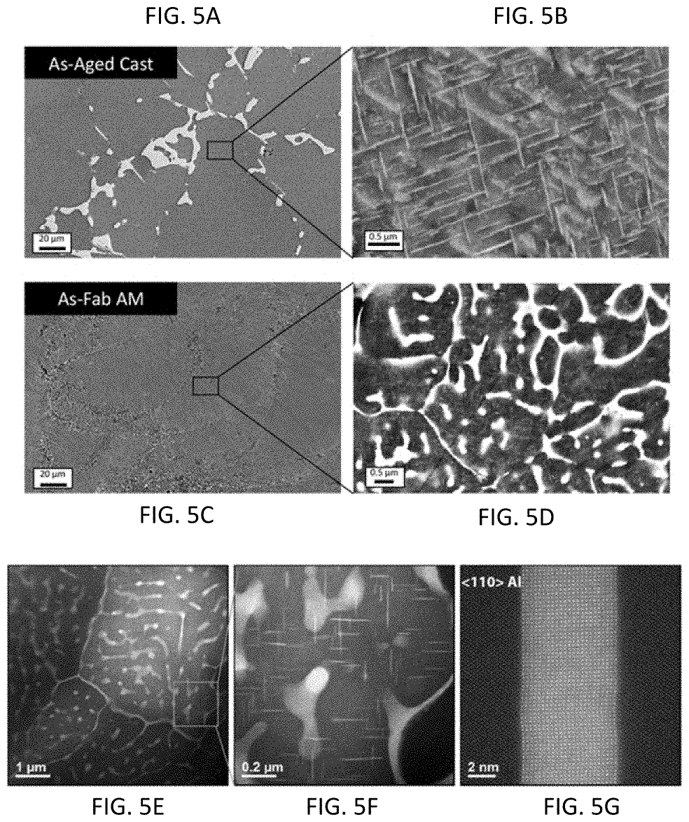

Embodiments of the disclosed additively manufactured (AM), or as-printed, ACMZ alloys include intermetallic phases. The intermetallic phases include Al₂Cu and Al₃Zr phases. Other phases also may be present. The AM ACMZ alloy exhibits a highly refined solidification structure, and evidence of in situ precipitation hardening. The refined solidification structure may be attributed, in part, to the higher cooling rates in additive processing. A cooperative eutectic microstructure is observed that is distinct from the divorced eutectic microstructure observed in comparable cast alloys (see, e.g., FIG. 5, discussed in detail in the examples below). A distribution of eutectic A (Al₂Cu) intermetallics and fine θ′ (Al₂Cu) intermetallic precipitates within the aluminum matrix are present in the AM alloy. Structural analysis is consistent with a body-centered tetragonal structure of the θ′ precipitate. In one example, in a cast alloy, particles of the Al₂Cu θ phase were coarse (approximate cross-sectional area range of 1-75 μm²) and decorated the grain boundaries (grain size of about 50 μm). In the as-printed ACMZ alloy, however, the intermetallic E phase was much finer (approximate cross-sectional area range 0.02-0.25 μm²) and was more evenly distributed throughout the microstructure. In any of the foregoing or following embodiments, the microstructure of the as-printed alloy may comprise θ intermetallic particles having particle spacing of 50 nm to 500 nm with a volume fraction of 0% to 50%. In some embodiments, the particle spacing varies inversely with the volume fraction, i.e., as the volume fraction increases, then particle spacing decreases. The volume fraction depends, at least in part, on the copper content of the ACMZ alloy. For example, a eutectic composition (33.7 wt % Cu) leads to nearly 50 vol % E intermetallic particles. In another example, when the Cu content is 9 wt %, the as-printed alloy may comprise ˜10 vol % E intermetallic particles. In some embodiments, the volume fraction of θ intermetallics is 5% to 50%, such as 5% to 30%, 5% to 25%, 5% to 20%, or 7% to 15%.

In any of the foregoing or following embodiments, the θ′ intermetallic precipitates may have an average diameter of 0.1 μm to 0.3 μm. In some embodiments, the θ′ intermetallic precipitates may have an average diameter to average thickness aspect ratio within a range of from 3 to 100, such as 5 to 100, 10 to 100, 10 to 75, 10 to 50, or 20 to 50. Advantageously, in contrast to cast alloys, the θ′ intermetallic precipitates may form in situ in the as-printed alloy without the need for subsequent heat treatments.

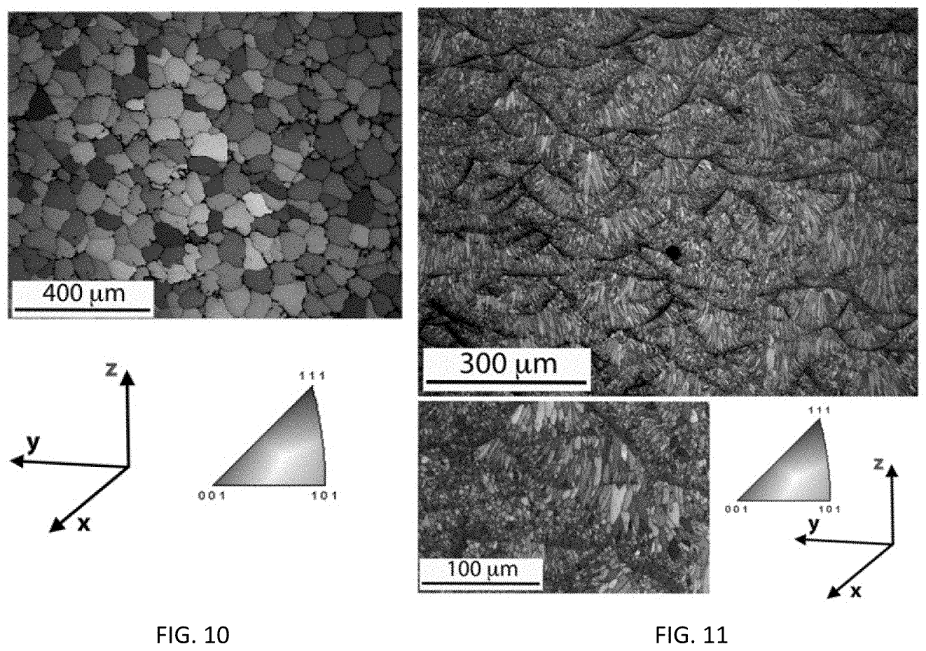

Comparable cast alloys exhibit an equiaxed grain structure with no strong orientation texture (see, e.g., FIG. 10, discussed below). In stark contrast, however, the microstructure of as-printed ACMZ alloy embodiments of the present disclosure includes overlapping melt pools with a “peacock-tail” microstructure comprising a bimodal distribution of equiaxed grains in the bottom of the melt pool and columnar grains arrayed in an angular pattern at the top of at least some melt pools (see, e.g., FIG. 11, discussed below). Other melt pools may have very fine equiaxed grains alone. In some embodiments, the columnar grains of the disclosed as-printed ACMZ alloys have a high aspect ratio (see, e.g., FIG. 11, discussed below), such as an average length-to-width aspect ratio greater than 3 For example, the aspect ratio may be from greater than 3 to 20, such as 3 to 15, 3 to 10, or 3 to 5. When determining the aspect ratio, the width is an average width of the columnar grain or the width measured halfway along the grain length. This distinct microstructure provides embodiments of the disclosed AM ACMZ alloys with both desirable strength and ductility.

In any of the foregoing or following embodiments, the mechanical properties of the disclosed AM ACMZ alloys, particularly at elevated temperatures, may exceed those of current commercially available aluminum alloys for additive manufacturing and/or those of comparable cast ACMZ alloys. Without wishing to be bound by a particular theory of operation, the improved mechanical properties may be attributed to the refined microstructural features and/or the presence of both equiaxed grains and columnar grains. For example, improved tensile strength may result from a high volume fraction of particles present in the as-printed ACMZ alloy.

In any of the foregoing or following embodiments, the as-printed alloy may have an ultimate tensile strength of at least 250 MPa throughout a temperature range of 25° C. to 200° C. In some embodiments, the ultimate tensile strength through the temperature range of 25° C. to 200° C. is at least 275 MPa, or at least 300 MPa, such as 250 MPa to 450 MPa, 275 MPa to 450 MPa, or 300 MPa to 450 MPa, as determined by ASTM standards E8 and E21.

In any of the foregoing or following embodiments, the as-printed alloy may have a yield strength of at least 200 MPa throughout a temperature range of 25° C. to 200° C., such as a yield strength of at least 225 MPa, at least 250 MPa, 200 MPa to 300 MPa, 225 MPa to 300 MPa, or 250 MPa to 300 MPa, as determined by ASTM standard E21. In one example, an ACMZ alloy as disclosed herein exhibited a 70-100 MPa higher yield strength than a commercially available additively manufactured Al—Mg—Zr alloy at temperatures above 200° C.

In any of the foregoing or following embodiments, the as-printed alloy may exhibit an elongation of at least 10% throughout a temperature range of 25° C. to 250° C., such as an elongation of 10% to 25% or 10% to 20%, as determined by ASTM standard E21. In some embodiments, the as-printed alloy exhibits an elongation of at least 20% throughout a temperature range of 200° C. to 300° C., such as an elongation of 20% to 30%. In some implementations, the elongation of the additively manufactured ACMZ alloy disclosed herein is at least 2× greater, such as 2 to 3× greater, than the elongation of a comparable (similar Cu, Mn content) cast alloy at both room temperature and temperatures up to 300° C. Without wishing to be bound by a particular theory of operation, the increased ductility, evidenced by the elongation, may be attributable to an absence of the larger brittle intermetallics found at the grain boundary in the cast alloy, as well as to the presence of the cooperative eutectic morphology provided by additive manufacturing.

Embodiments of the disclosed alloys are useful for fabricating objects via additive manufacturing. In some embodiments, the fabricated objects are useful in a variety of applications, including applications at elevated temperatures, such as temperatures up to 400° C., for example, 250° C. to 400° C. Exemplary fabricated objects include, but are not limited to, automotive and aerospace components, such as engine components. Advantageously, the fabricated objects may displace titanium components in a wide variety of applications with increased performance, increased fuel efficiency, and/or decreased cost.

### III. ALLOY FEEDSTOCKS AND METHODS OF MAKING

Also disclosed herein are embodiments of a method for making objects comprising the alloy embodiments described herein. In some embodiments, the method comprises using a layer-by-layer manufacturing method that uses an energy source, such as direct metal laser sintering, direct energy deposition, electron beam melting, selective heat sintering, selective laser melting, selective laser sintering, laser powder bed additive manufacturing, and microinduction.

Alloy embodiments of the present disclosure can be used in the method and are in the form of an alloy feedstock. In some embodiments, the alloy feedstock is in the form of a powder. In particular embodiments, the feedstock powder is an ACMZ alloy powder in which the powder particles are made of the ACMZ alloy. In some embodiments, the feedstock powder can be sieved to provide a particular size distribution. In representative embodiments described herein the size distribution can range from 10 μm to 150 μm, such as 10 μm to 100 μm, 15 μm to 75 μm, or 20 μm to 65 μm. However, other powder particle and/or grain sizes can be made depending on the additive manufacturing technique to be used. These would be recognized by person of ordinary skill in the art with the guidance of the present disclosure.

The feedstock powder particles may be alloy particles having any ACMZ alloy composition disclosed herein. In some embodiments, the particles of the feedstock powder comprise 5 wt % to 35 wt % copper, 0.05 wt % to 3.0 wt % manganese, 0.5 wt % to 5.0 wt % zirconium, 0 wt % to 3 wt % iron, 0 wt % to less than 1 wt % silicon, and aluminum. In one implementation, the particles of the feedstock powder comprise 5 wt % to 35 wt % copper, 0.05 wt % to 3.0 wt % manganese, greater than 0.5 wt % to 5.0 wt % zirconium, 0 wt % to 3 wt % iron, 0 wt % to less than 1 wt % silicon, and aluminum. In another implementation, the particles comprise 8 wt % to 15 wt % copper, 0.3 wt % to 0.6 wt % manganese, and 0.55 wt % to 2 wt % zirconium. In another implementation, the particles comprise 8 wt % to 15 wt % copper, 0.4 wt % to 0.5 wt % manganese, 0.7 wt % to 1.5 wt % zirconium, 0 wt % to less than 0.1 wt % iron, 0 wt % to less than 0.1 wt % silicon, and aluminum. In still another implementation, the particles comprise 8 wt % to 12 wt % copper, 0.4 wt % to 0.5 wt % manganese, 0.8 wt % to 1.2 wt % zirconium, 0 wt % to less than 0.1 wt % iron, 0 wt % to less than 0.1 wt % silicon, and aluminum.

In particular embodiments, the method comprises using a device, such as a device used in a laser-based additive manufacturing method, to make the object from an alloy composition. The device can include a powder bed, an energy source, a build platform, a deposition apparatus capable of depositing the alloy feedstock (e.g., a roller, a blade, and the like), and other suitable components that will be recognized by a person of ordinary skill in the art with the benefit of the present disclosure. In some embodiments, the method comprises adding a first amount of an alloy feedstock as disclosed herein to a build platform; exposing the first amount, or a portion thereof, of the alloy feedstock to an energy source to provide a first energy-treated region on the build platform, wherein the first energy-treated region comprises an alloy material; adding a second amount of the alloy feedstock to the build platform, wherein the second amount of the alloy feedstock is positioned immediately adjacent to the first energy-treated region on the build platform; and exposing the second amount, or a portion thereof, of the feedstock to the energy source to provide a second energy-treated region on the build platform, wherein the second energy-treated region comprises the alloy material. In some embodiments, the alloy feedstock is contained in a powder bed that is coupled to the building platform.

The energy source can be a laser or other energy source sufficient to provide sufficient energy to melt and consolidate the feedstock (e.g., a laser, a heater, an electron beam, or the like). In some embodiments, when exposed to the energy source, the feedstock is sintered and/or melted to provide an energy-treated region (e.g., a consolidated region). This region can be allowed to cool and solidify. The process is repeated to provide sequential layers of energy-treated regions that become fused together during the process, thereby producing the fabricated object. In any of the foregoing or following embodiments, the laser may have a power of 250 W to 500 W, such as 300 W to 450 W, or 350 W to 400 W. In any of the foregoing or following embodiments, the laser velocity may be 1000 ms/ to 2000 m/s, such as 1000 m/s to 1500 ms/s, or 1200 m/s to 1400 m/s. In any of the foregoing or following embodiments, the laser spot size may be any suitable size, such as 50 μm to 150 μm, 50 μm to 100 μm, 75 μm to 100 μm, or 90 μm to 100 μm. In some embodiments, the hatch spacing (separation between two consecutive laser beams) is 0.1 mm to 0.2 mm. In certain embodiments, a scan pattern is used to modify the grain structure of the ACMZ alloy during fabrication. In particular implementations, the scan pattern is a skip raster technique. In a skip raster technique, a first raster is performed with a hatch spacing that is wider than usual, such as twice the hatch spacing of a traditional raster, such that it “skips” every other scan line. Upon completion of the first pass, the laser returns to the beginning and a second raster is performed with scan lines between the previous scan lines. The skip raster technique may reduce heat input into local regions of the build and minimize defect density.

In any of the foregoing or following embodiments, the method can further comprise pre-heating the build plate upon which the alloy is deposited during fabrication. In some embodiments, the build plate is preheated to a temperature of 150° C. to 250° C., such as 175° C. to 225° C., or 190° C. to 210° C. In some embodiments, method parameters can be modified to increase growth velocity, such as by increasing the laser velocity and decreasing the preheat temperature, particularly for laser powder bed fusion additive manufacturing. In yet some additional embodiments, additional heat treatment steps can be performed. In some such embodiments, the additional heat treatment could further increase strength, ductility, or a combination thereof.

### IV. OVERVIEW OF REPRESENTATIVE EMBODIMENTS

Several representative, non-limiting embodiments are set forth in the following paragraphs.

An additively manufactured alloy may comprise 5 wt % to 35 wt % copper, 0.05 wt % to 3 wt % manganese, 0.5 wt % to 5 wt % zirconium, 0 wt % to 3 wt % iron, 0 wt % to less than 1 wt % silicon, and aluminum.

In some embodiments, the additively manufactured alloy (i) has an ultimate tensile strength of at least 250 MPa throughout a temperature range of 25° C. to 200° C.; or (ii) has a yield strength of at least 200 MPa throughout a temperature range of 25° C. to 200° C.; or (iii) exhibits an elongation of at least 10% throughout a temperature range of 25° C. to 250° C.; or (iv) exhibits an elongation of at least 20% throughout a temperature range of 200° C. to 300° C.; or (v) any combination of (i), (ii), (iii), and (iv).

In any of the foregoing or following embodiments, the additively manufactured alloy may comprise (i) a microstructure comprising θ′ intermetallic precipitates having an average diameter of 0.1 μm to 0.3 μm; or (ii) a microstructure comprising θ intermetallic particles having particle spacing of 50-500 nm with a volume fraction of 0-50%; (iii) or both (i) and (ii). In any of the foregoing or following embodiments, the alloy as printed may comprise a microstructure comprising a bimodal distribution of equiaxed grains and columnar grains having an average length-to-width aspect ratio greater than 3.

In any of the foregoing or following embodiments, the additively manufactured alloy may comprise an Al₃Zr intermetallic phase.

In one implementation, the additively manufactured alloy comprises 8 wt % to 15 wt % copper, 0.3 wt % to 0.6 wt % manganese, and 0.55 wt % to 2 wt % zirconium. In another implementation, the additively manufactured alloy comprises 8 wt % to 12 wt % copper, 0.4 wt % to 0.5 wt % manganese, and 0.7 wt % to 1.5 wt % zirconium. In still another implementation, the additively manufactured alloy comprises 8 wt % to 15 wt % copper, 0.4 wt % to 0.5 wt % manganese, 0.7 wt % to 1.5 wt % zirconium, 0 wt % to less than 0.1 wt % iron, 0 wt % to less than 0.1 wt % silicon, and aluminum. In yet another implementation, the additively manufactured alloy comprises 8 wt % to 12 wt % copper, 0.4 wt % to 0.5 wt % manganese, 0.8 wt % to 1.2 wt % zirconium, 0 wt % to less than 0.1 wt % iron, 0 wt % to less than 0.1 wt % silicon, and aluminum.

In one implementation, the additively manufactured alloy consists essentially of 8 wt % to 15 wt % copper, 0.4 wt % to 0.5 wt % manganese, 0.7 wt % to 1.5 wt % zirconium, 0 wt % to less than 0.1 wt % iron, 0 wt % to less than 0.1 wt % silicon, and aluminum. In another implementation, the additively manufactured alloy consists of 8 wt % to 15 wt % copper, 0.4 wt % to 0.5 wt % manganese, 0.7 wt % to 1.5 wt % zirconium, 0 wt % to less than 0.1 wt % iron, 0 wt % to less than 0.1 wt % silicon, and aluminum.

A fabricated object comprises the additively manufactured alloy of any of the foregoing embodiments.

An alloy for additive manufacturing may comprise 5 wt % to 35 wt % copper, 0.05 wt % to 3 wt % manganese, greater than 0.5 wt % to 5 wt % zirconium, 0 wt % to 3 wt % iron, 0 wt % to less than 1 wt % silicon, and aluminum.

An alloy feedstock for additive manufacturing may comprise a powder comprising particles having an average particle size of 10 μm to 150 μm, the particles comprising 5 wt % to 35 wt % copper, 0.05 wt % to 3.0 wt % manganese, 0.5 wt % to 5.0 wt % zirconium, 0 wt % to 3 wt % iron, 0 wt % to less than 1 wt % silicon, and aluminum.

In one implementation, the particles comprise 8 wt % to 15 wt % copper, 0.3 wt % to 0.6 wt % manganese, and 0.55 wt % to 2 wt % zirconium. In another implementation, the particles comprise 8 wt % to 15 wt % copper, 0.4 wt % to 0.5 wt % manganese, 0.7 wt % to 1.5 wt % zirconium, 0 wt % to less than 0.1 wt % iron, 0 wt % to less than 0.1 wt % silicon, and aluminum. In still another implementation, the particles comprise 8 wt % to 12 wt % copper, 0.4 wt % to 0.5 wt % manganese, 0.8 wt % to 1.2 wt % zirconium, 0 wt % to less than 0.1 wt % iron, 0 wt % to less than 0.1 wt % silicon, and aluminum.

A method for making a fabricated object comprises (a) adding a first amount of the alloy feedstock of any of the foregoing paragraphs to a build platform, (b) exposing the first amount, or a portion thereof, of the alloy feedstock to an energy source to provide a first energy-treated region on the build platform, (c) adding a second amount of the alloy feedstock to the build platform, wherein the second amount of the alloy feedstock is positioned immediately adjacent to the first energy-treated region on the build platform, d) exposing the second amount, or a portion thereof, of the alloy feedstock to the energy source to provide a second energy-treated region on the build platform, and repeating one or more of steps (a), (b), (c), and (d) to fabricate an object. In some embodiments, the method further comprises preheating the build platform to a temperature of 150° C. to 250° C. prior to one or more of steps (a), (b), (c), and (d).

In any of the foregoing or following embodiments, each of the first energy-treated region and the second energy-treated region may comprise a consolidated alloy formed from melting and consolidating particles of the alloy feedstock.

In any of the foregoing or following embodiments, the energy source may be a laser. In some embodiments, exposing to the energy source comprises performing a skip raster scan pattern with the laser.

### V. EXAMPLES

### Example 1

Components of a representative ACMZ alloy were fabricated by additive manufacturing. The nominal composition and the measured composition of as-fabricated AM components and a comparative cast ACMZ are given in Table 1.

TABLE 1
All values given in wt %

| | ACMZ | ACMZ as | |
|---|---|---|---|
| Element | Nominal | Fabricated | Cast ACMZ |
| Al | Balance | Balance | Balance |
| Cu | 9 | 8.61 | 8.9 |
| Mn | 0.45 | 0.45 | 0.43 |
| Zr | 1 | 0.90 | 0.20 |
| Fe | <0.1 | 0.09 | 0.08 |
| Si | <0.1 | 0.06 | 0.08 |
| Ce | — | 0.19 | — |

A design of experiments was performed using a Concept Laser M2 laser powder bed fusion additive manufacturing system. The alloy powder was processed system in nitrogen atmosphere. A wide range of processing conditions were tested to identify a suitable set of processing parameters that did not result in cracking or excessive porosity. The alloy was found to be hot tear prone for a subset of AM process conditions. A single parameter set was selected for fabrication of additional components. The process conditions A are summarized in Table 2, along with a nominally similar set of process conditions B that resulted in a high microcrack density. The selected parameter set included a non-standard raster called a skip raster. The skip raster doubles the hatch spacing of a traditional raster, and on completion of a first pass, returns to the beginning and fills in the un-melted regions. Such a skip raster was developed to reduce the heat input into local regions of the build.

TABLE 2
Process parameters for additive manufacturing
of the ACMZ alloy.

| | A-No | |
|---|---|---|
| Parameter | hot-tearing | B-Hot tearing |
| Preheat temperature (° C.) | 200 | 200 |
| Laser velocity (m/s) | 1.3 | 1300 |
| Laser power (W) | 370 | 250 |
| Hatch spacing (mm) | 0.15 | 0.15 |
| Spot size (μm) | 95 | 80 |
| Layer thickness (μm) | 200 | 200 |

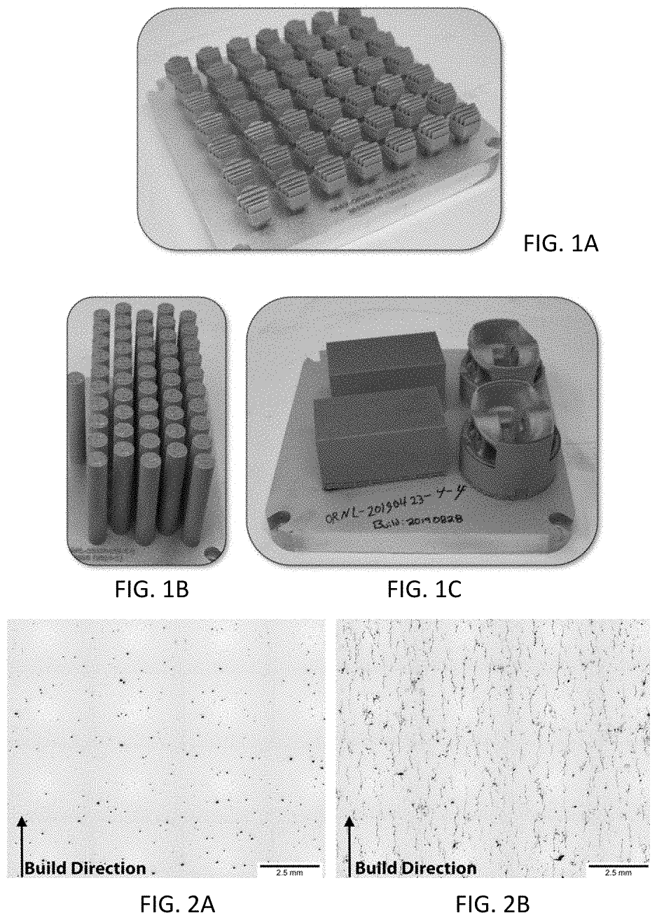

Parameter set A was used to produce several geometries as shown in FIGS. 1A-1C, including mechanical test coupons (FIG. 1B) and automotive pistons (FIG. 1C). AGS. 2A-2B are optical micrographs showing the effects of processing parameters (set Al that resulted in no hot tearing (FIG. 2A) and parameters (set B) that produced hot tearing or hot cracking (FIG. 2B). The relative density produced by parameter set A was measured using image analysis of mosaic optical micrographs and found to be approximately 99.3%.

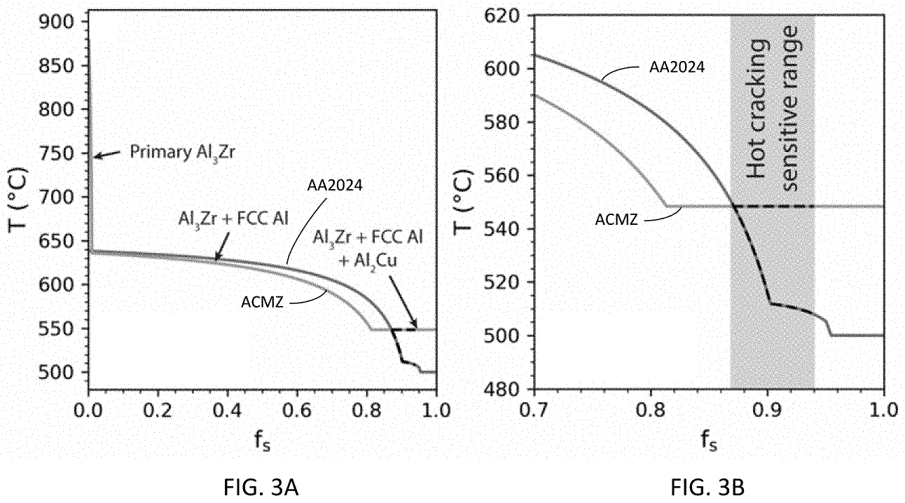

The hot cracking resistance of the additively manufactured Al—Cu—Mn—Zr alloy can be rationalized by considering a Scheil simulation of the solidification path. FIGS. 3A-3B show the Scheil simulation of the printed alloy composition (from Table 1) calculated from Pandat software (Cao et al., Calphad 2009, 33(2):328-342), as well as a simulation for the highly hot crack sensitive conventional AA2024 Al—Cu based wrought alloy (93.5 wt % Al, 4.5 wt % Cu, 1.5 wt % Mg, 0.5 wt % Mn). Models for hot-cracking have shown that the susceptibility of an alloy to crack formation is linked to its behavior during the terminal stages of solidification. The difference in solidification behavior in this range, where the increased Cu content (9 wt. %) of the ACMZ alloy promotes a eutectic reaction that results in a flat temperature response in the solid fraction region of 0.87-0.94, whereas AA2024 has a comparatively large solidification temperature interval.

The preheat temperature for the system was 200° C., which is sufficient for ageing of Al—Cu based alloys. The AM build for microstructure and properties evaluation included 51 vertically oriented cylindrical coupons (manufactured using parameter set A) with a diameter of 10 mm and height of 115 mm. Specimens for tensile testing were machined from these cylindrical coupons. The total build duration was 131 hours (˜2.5 h/cylinder). The average Vickers hardness in the tensile testing specimen blank was ˜118 kg/mm² with no significant dependence on build height. The original cast specimens were prepared and heat treated according to procedures reported recently (Bahl et al., Mater. Sci. Eng.: A 2020, 772:138801). It is noted that for the cast specimens an external grain refiner (0.1 wt % Ti via Al-5 wt % Ti-1 wt % B) was added prior to the pour.

Specimens for scanning electron microscopy (SEM, Hitachi S4800) and electron back scattered diffraction (EBSD, Tescan Mira3) were prepared using standard metallographic techniques. Colloidal silica was used in the final polishing step. SEM specimens were further etched in Keller's reagent containing 2.5% HNO₃, 1.5% HCl, and 1% HF by volume in water. EBSD data was acquired using the TEAM software (EDAX) at 20 kV accelerating voltage and ˜25 mm working distance. Step sizes of 0.5 μm and 2.0 μm were used for additive and cast alloys, respectively. EBSD data was analyzed using OIM Analysis software (EDAX). Thin foil specimens for high-angle annular dark-field scanning transmission electron microscopy (HAADF-STEM) were prepared by electropolishing techniques reported recently (Shyam et al., Mater. Sci. Eng.: A 2019, 765:138279). The thin foils were imaged with a JEOL 2200FS instrument fitted with a CEOS GmbH (Heidelberg, Ger.) aberration corrector.

Tensile specimens were machined from printed cylinders with a 6.35 mm gage diameter and strain was measured with a 25.4 or 31.75 mm gage length axial extensometer (for details, see Plotkowski et al., Acta Materialia 2020, 196:595-608). Room temperature and elevated temperature tensile tests were performed according to ASTM standards E8 and E21, respectively. Average values and standard deviations of tensile mechanical properties for two cast and four additive specimens are reported. Mechanical testing was performed at elevated temperatures ranging from 200 to 300° C. with a ramp rate of 10° C./min and a 30 min soak time prior to testing. The cast specimens were given an additional 200 hour preconditioning treatment at the testing temperature beyond the ageing treatment (540° C./5 hour solution, 80° C. water quench, 240° C./5 hour ageing). Room temperature tests were performed in displacement control at an initial strain rate of 1.17×10⁻⁴ s⁻¹. The elevated temperature tensile tests were initiated at a strain rate of 8.33×10⁻⁵ s⁻¹, which was subsequently increased to 8.33×10⁻⁴ s⁻¹ once ˜2% strain was achieved per the ASTM E21 standard.

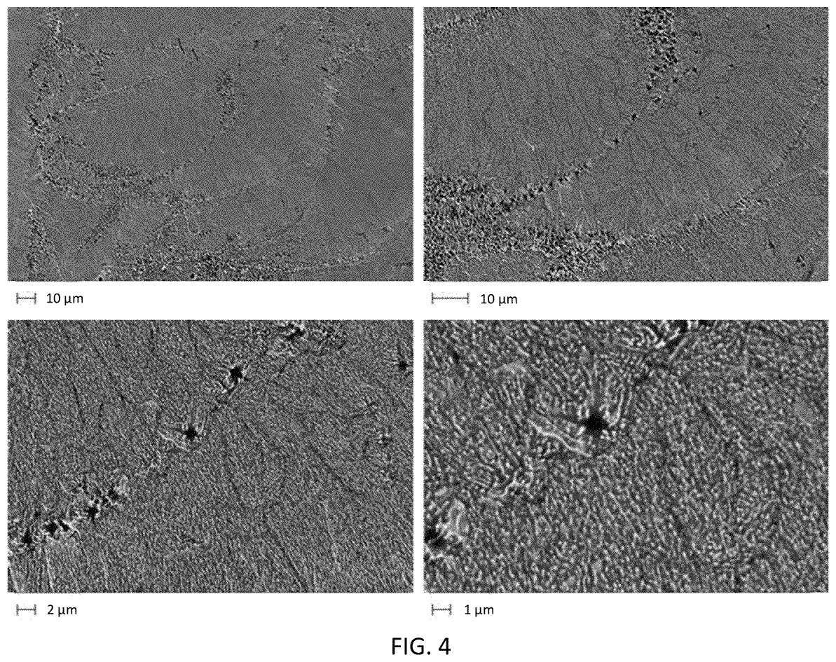

Scanning electron micrographs of the microstructure of the as-fabricated alloy are shown in FIG. 4. The alloy includes predominantly eutectic structures, likely composed of Al+θ (Al₂Cu). The spacing of the eutectic structure is less than 1 μm, which is highly refined compared to the cast structure for alloys of similar composition.

A direct comparison of the microstructure for conventionally processed (cast and aged) and the additively manufactured material (“As-Fab AM”) is shown in FIGS. 5A-5a FIGS. 5A-5D compare the SEM microstructure of the cast ACMZ alloy in the aged condition (5A, 5B) to the as-printed microstructure (5C, 5D) for the alloys presented in Table 1. The grain boundary intermetallic phase (θ-Al₂Cu) and strengthening precipitates (θ′-Al₂Cu) are readily observed in the cast microstructure (FIGS. 5A and 5B, respectively). Distribution of the intermetallic in the additively processed microstructure is considerably refined and a co-operative eutectic microstructure is observed that is distinct from the divorced eutectic microstructure observed in the cast state. Melt pool boundaries associated with higher temperature gradients and lower solid-liquid interfacial growth velocities during solidification can be discerned as lighter boundary regions in FIG. 5C. FIG. 5D shows a distribution of eutectic intermetallics and fine θ′ (Al₂Cu) precipitates within the aluminum matrix in the AM alloy. The morphology of the intermetallic θ precipitates in FIG. 5D is similar to that observed in the grain boundary θ precipitates in the cast state in FIG. 5A but with significant refinement in size. The HAADF-STEM images show the morphology of the eutectic colony microstructure at a grain scale in FIG. 5E, while high aspect ratio θ′ precipitates are observed in a <100> αAl zone axis image in FIG. 5F. An atomic resolution stand-alone θ′ precipitate image from an adjacent <110> aluminum grain is shown in FIG. 5G. Structural analysis of the precipitate in FIG. 5G is consistent with the body centered tetragonal structure of the θ′ precipitate. It is currently believed that the finer θ′ precipitates (compared to as-aged cast alloy in FIG. 5B) form in-situ during additive processing because the baseplate is maintained at a temperature of 200° C.

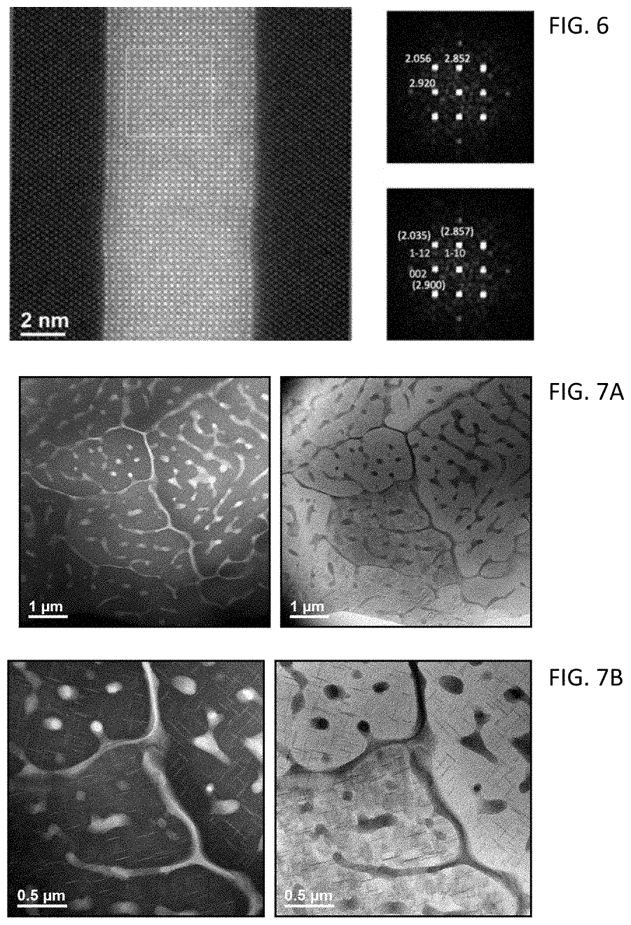

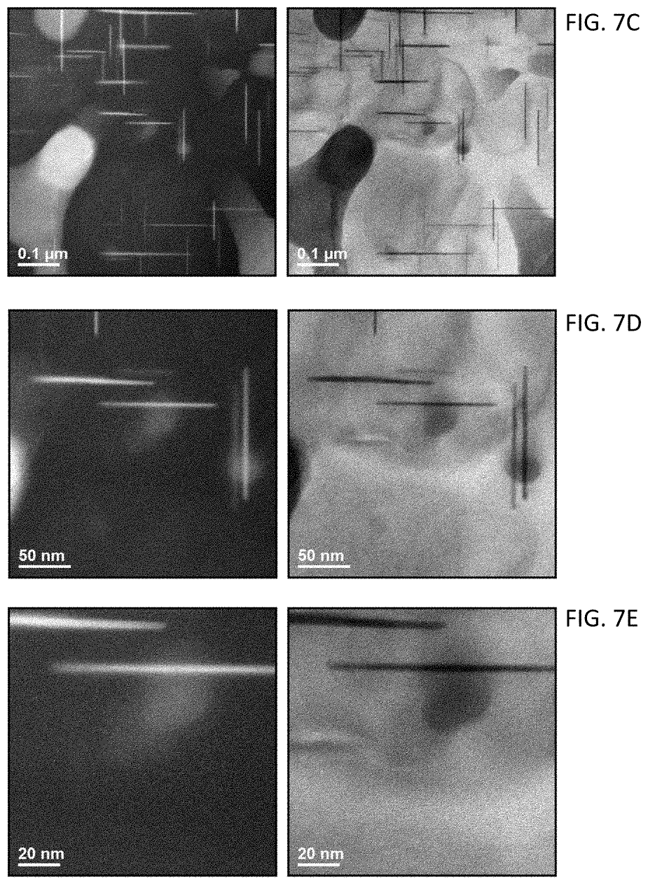

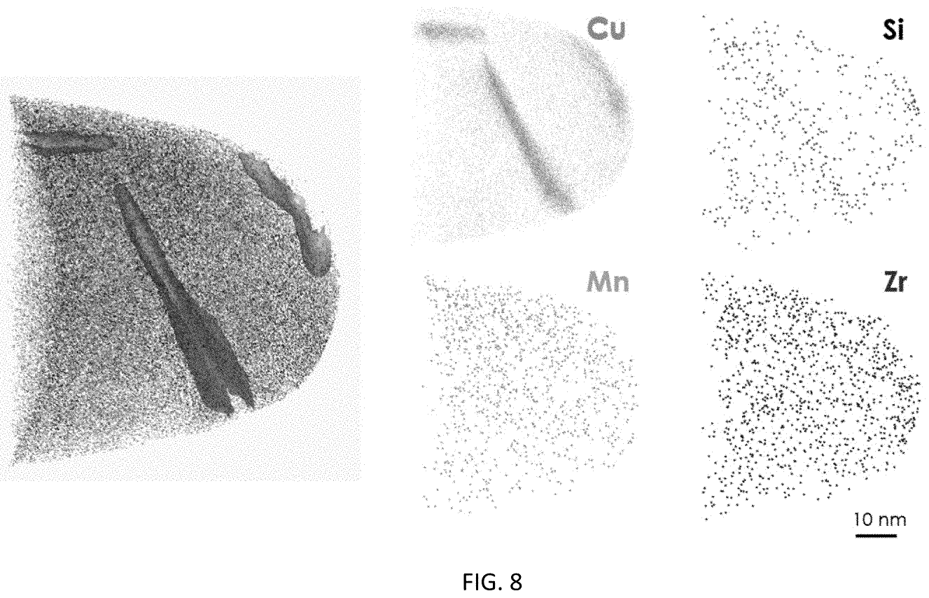

The structure of the precipitate in FIG. 5G was analyzed with the fast Fourier transformation (FFT) method. The resulting structural analysis is presented in FIG. 6. Higher lattice spacing in the thickness direction compared to the in plane lattice parameter is consistent with the body centered tetragonal structure of the θ′ precipitate. FIGS. 7A-7E are high-resolution scanning tunneling electron microscopy (HR-STEM) images of the additively manufactured alloy at increasing magnifications. FIG. 8 shows atom probe results for a region of the alloy including θ′ (Al₂Cu) precipitates within the aluminum matrix. As seen in FIG. 8, copper is concentrated in the θ′ precipitates, while Si, Mn, and Zr are more evenly distributed throughout the alloy.

Tables 3 and 4 show composition summaries (atomic percent) of the elements taken at several regions in the θ′ precipitates and aluminum matrix, respectively. The results show that the Cu is concentrated in the θ′ precipitates, while the Zr is more evenly distributed and has a high solubility throughout the Al matrix.

TABLE 3
Composition Summary-θ′ Precipitate.

| Element | Atomic % | Atomic % | Atomic % | Atomic % |
|---|---|---|---|---|
| Cu | 26.21 ± 0.18 | 23.34 ± 0.17 | 23.36 ± 0.28 | 23.75 ± 0.14 |
| Si | 0.25 ± 0.02 | 0.09 ± 0.01 | 0.09 ± 0.02 | 0.34 ± 0.02 |
| Zr | 0.40 ± 0.03 | 0.37 ± 0.02 | 0.49 ± 0.05 | 0.43 ± 0.02 |
| Mn | 0.40 ± 0.03 | 0.34 ± 0.02 | 0.37 ± 0.04 | 0.45 ± 0.02 |

TABLE 4
Composition Summary-Aluminum Matrix.

| Element | Atomic % | Atomic % | Atomic % | Atomic % |
|---|---|---|---|---|
| Cu | 0.31 ± 0.00 | 0.33 ± 0.01 | 0.33 ± 0.02 | 0.39 ± 0.02 |
| Si | 0.01 ± 0.00 | 0.01 ± 0.00 | 0.01 ± 0.00 | 0.02 ± 0.00 |
| Zr | 0.30 ± 0.00 | 0.36 ± 0.01 | 0.27 ± 0.02 | 0.28 ± 0.02 |
| Mn | 0.23 ± 0.00 | 0.21 ± 0.00 | 0.20 ± 0.01 | 0.26 ± 0.02 |

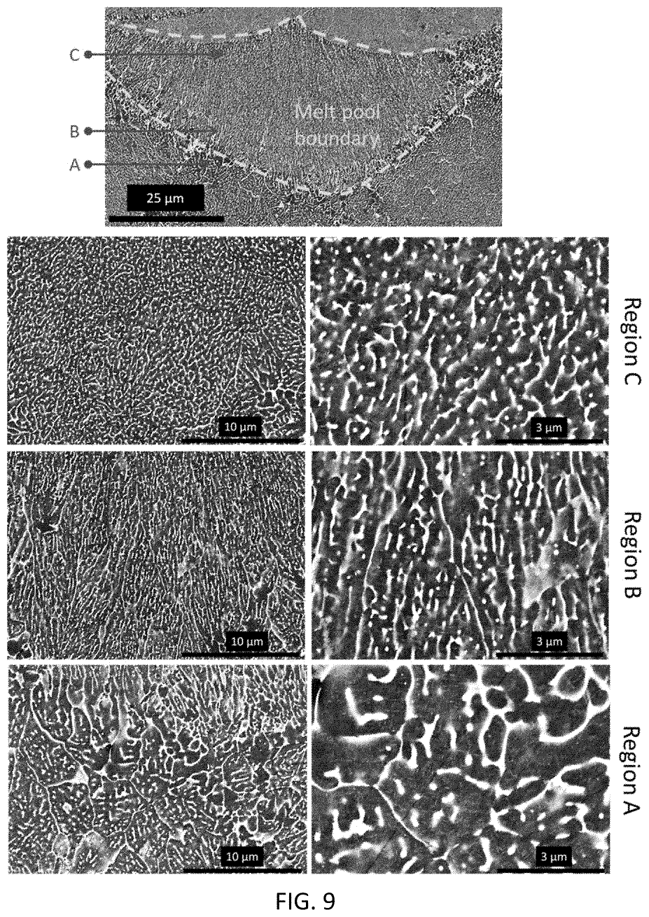

The structure in the additively manufactured samples is several orders of magnitude finer with grain size itself being about an order of magnitude finer. Particles of the Al₂Cu θ phase were coarse (approximate cross-sectional area range of 1-75 μm²) and decorated the grain boundaries (grain size of about 50 μm) in the cast material. In the additively manufactured sample, the intermetallic phase was much finer (approximate cross-sectional area range 0.02-0.25 μm²) and was more evenly distributed throughout the microstructure. This highly refined structure contributes to all around improvement (strength and ductility) in the mechanical properties of the as-fabricated material. The length scale of the structure varies slightly as a function of the varying thermal conditions during solidification, which manifests as a heterogeneous distribution across the melt pools in the additively manufactured microstructure. An example of the range of microstructures observed as a function of location in the melt pool is shown in FIG. 9.

The alloy is strengthened in part by the incoherent θ phase in this structure, but a far more potent strengthening mechanism is precipitation of the nanoscale metastable θ′ phase, which is semi-coherent with the FCC Al crystal structure. For the cast material, this phase is produced through a series of heat treatments. In the additively manufactured material, there is evidence of θ′ precipitates in the as-fabricated structure. Because of their mix of coherent and semi-coherent interfaces with the Al crystal structure, θ′ particles exhibit a platelet morphology. In high magnification scanning electron micrographs, these phases are clearly visible in the Al portion of the eutectic structure. Several examples are pointed out by arrows in FIG. 9.

EBSD grain orientation maps of the as-aged cast and as-fabricated AM microstructures of the Al-9Cu—Mn—Zr alloys are presented in FIGS. 8 and 9, respectively. The build direction (z) is from bottom to top. An equiaxed grain structure with no strong orientation texture is present in the cast alloy (FIG. 10). The as-printed microstructure (FIG. 11) is distinct from the cast microstructure and includes overlapping melt pools with a “peacock-tail” microstructure comprising equiaxed grains in the bottom of the melt pool and columnar grains arrayed in an angular pattern at the top of several melt pools. Some melt pools had very fine equiaxed grains alone.

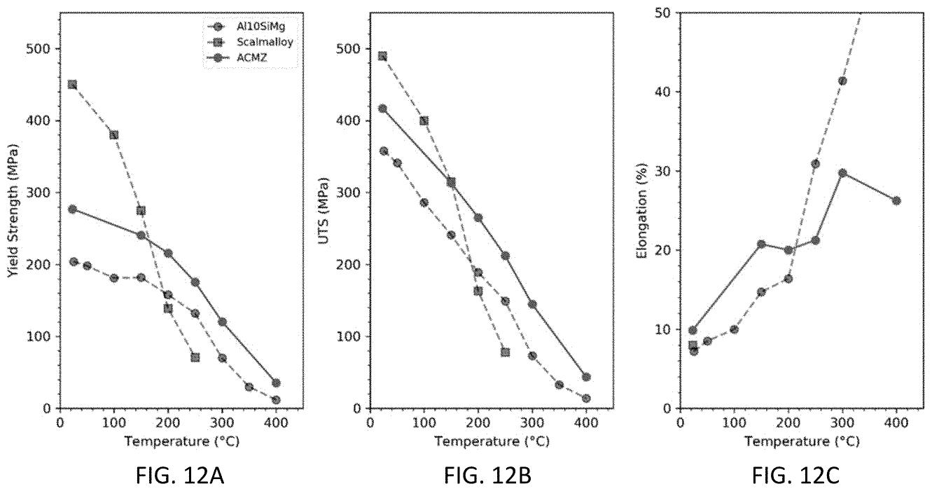

The tensile properties of the additively manufactured ACMZ alloy were measured as a function of test temperature, as described above, and compared to two commercial additively manufactured AM alloys. ASTM E8 standard tensile bars were used. Four tests were performed at each condition, and the average values of the yield strength, ultimate tensile strength, and elongation at break are plotted in FIGS. 12A-12C, as well as reference data for the two commercial additively manufactured AM alloys. The first reference alloy is Al10SiMg (Uzan et al., Addit. Manuf. 2018, 24:257-263), which is a common near-eutectic Al—Si alloy. The second alloy is Scalmalloy® (APWORKS, Taufkirchen, Germany), which is an expensive Al—Sc based alloy, Although the Scalmalloy® alloy had a higher yield and tensile strength at low temperature, the additively manufactured ACMZ alloy showed better strength at temperatures above approximately 150° C. The strength of the ACMZ alloy was higher than that of Al10SiMg across all test temperatures.

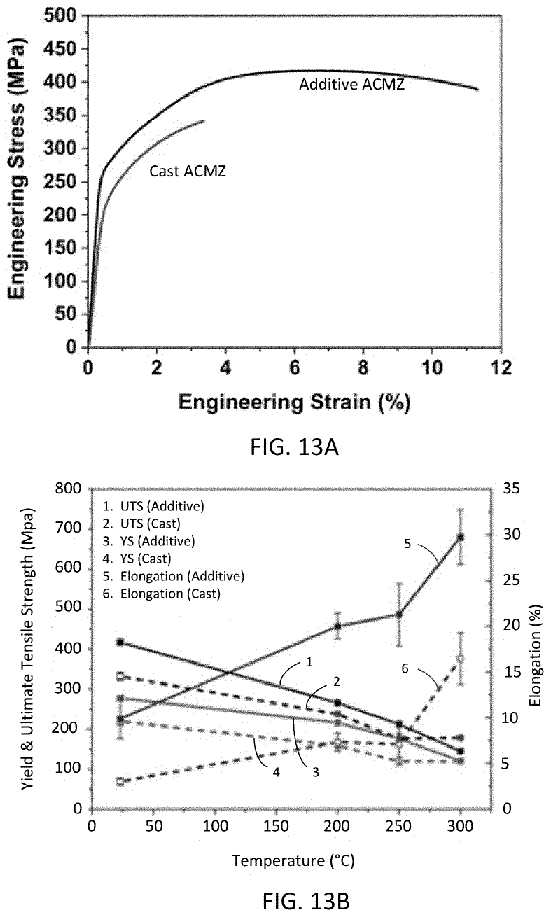

The tensile mechanical properties of the as-aged cast and as-printed ACMZ alloy microstructures are summarized in FIGS. 13A and 13B. FIG. 13A compares the ambient tensile curves for the as-aged cast alloy with the as-printed additive alloy. The as-printed additive microstructure has higher strength compared to the cast and aged microstructure and also improved tensile elongation. The strain hardening behavior of the alloys are comparable at room temperature. FIG. 13B reveals that at elevated temperature (up to 300° C.) the difference in the strength between the additive and cast microstructures persist until the strength values of the cast and additive alloy microstructures begin to converge at 300° C.

For the additive ACMZ alloy composition, besides SLM process parameter optimization (Table 2), two modifications were performed to the cast version of a 6.6 wt % Cu ACMZ alloy. Higher (9 wt %) Cu levels reduce hot cracking susceptibility through reduced solidification temperature range and constitutional under-cooling effects. Elevated Zr levels (0.9 wt % in Table 1 for the additive alloy) led to nucleation of equiaxed grains on Al₃Zr inoculants that form during additive processing. Formation of equiaxed grains during solidification also reduces hot cracking susceptibility.

The alloy chemistry modifications mentioned above along with the additive processing conditions can influence the microstructure formation for the additive ACMZ alloy. The “peacock tail” EBSD microstructure shown in FIG. 11 is a result of the nucleation of equiaxed grains at the base of the melt pool through Al₃Zr formation. Zr solutes remain trapped in the columnar grains as the melt pool velocity increases towards the center of the melt pool. Elevated copper levels have been demonstrated to effectively aid nucleation of grains in cast ACMZ alloys by increasing the level of constitutional supercooling. The presence of scattered melt pools with equiaxed grains alone (FIG. 11) may be attributed to processing conditions.

The processing parameters in this study were selected to generate a processing window for the manufacture of blanks for tensile specimen machining by minimization of processing defects. The base-plate temperature of 200° C. was selected to reduce the thermal gradient and residual stress buildup during additive processing. The preheat effectively increases the process parameter window in which hot cracking associated with additive processing can be managed. The 200° C. base plate temperature also allowed in-situ formation of the θ′ rich microstructure (FIGS. 5F, 5G) during printing with attractive mechanical properties. The formation of the θ′ precipitates during additive processing can be potentially advantageous for this technology as it eliminates the time and resources needed for solutionizing, quenching and ageing treatments. The θ′ phase strengthens Al—Cu alloy microstructures via multiple strengthening contributions. It is stated that although a θ′ precipitate rich microstructure was observed in the present investigation, the ageing response of the additive ACMZ alloy composition can be optimized further through baseplate temperature and other processing parameter variations.

The higher cooling rates in additive processing led to refinement in primary microstructural features, such as grains and intermetallic θ particles, and a concomitant increase in as-printed AM alloy strength compared to the as-aged cast ACMZ alloy which also includes a θ′ rich microstructure (FIG. 5B). FIG. 13A demonstrates that the strain hardening response for both the cast and additive compositions are similar. The ambient yield strength of the additive ACMZ alloy reported here is comparable to that reported by Griffiths et al. (Acta Mater. 2020, 188:192-202) for an additive Al—Mg—Zr alloy. At temperatures above 200° C. (FIG. 13B), the as-printed additive ACMZ alloy has 70-100 MPa higher yield strength than that reported for the as-fabricated Al—Mg—Zr alloy (Ibid.). The improved tensile mechanical properties of the additive ACMZ alloy can be explained by the beneficial effect coming from the plate shaped θ′ particles that are efficient strengtheners in age hardened aluminum alloys, particularly in the temperature range 200° C. The dramatic increase in grain boundary area in the additive microstructures, however, could lead to a penalty in creep resistance of additive ACMZ alloys (Ibid.) at elevated temperatures, when compared to cast alloys (compare FIGS. 10 and 11). The narrowing of the gap of elevated temperature yield and tensile strengths between the AM and cast ACMZ alloys (FIG. 13B) could be attributed to enhanced creep deformation in the additive alloy, especially at 300° C.

Surprisingly, the refinement of the microstructure led to a 2-3× increase in the room and elevated temperature (<300° C.) tensile elongation of the as-printed alloy compared to the cast alloy. This bimodal distribution of grain size is also observed in the additive ACMZ alloy (see FIG. 9 inset). Without wishing to be bound by a particular theory of operation, an additional contribution to the increase in ductility of the additive ACMZ alloy comes from the absence of larger brittle intermetallics (FIG. 5A for the cast alloy) at the grain boundary which have been shown to directly limit the ductility of cast ACMZ alloys with up to 9 wt % Cu (Bahl et al., Mater. Sci. Eng.: A 2020, 772:138801). The significant refinement in size (FIG. 5D) and the cooperative eutectic morphology resulting from additive processing likely provide advantages in the overall tensile properties as well.

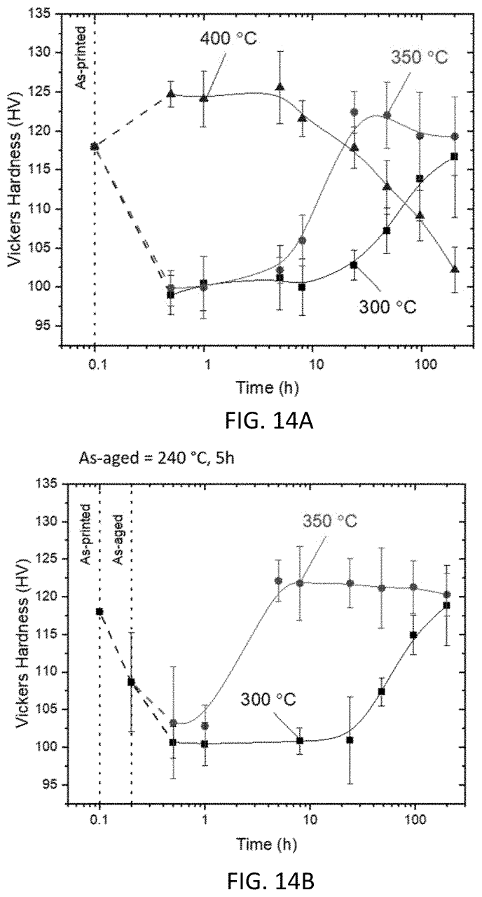

FIGS. 14A and 14B show the effects of aging at various temperatures on Vickers hardness of an additively manufactured ACMZ alloy as printed (FIG. 14A) and after aging for 5 hours at 240° C. (FIG. 14B). The data shows that the as-printed alloy retained its hardness at 400° C. for an extended period of time. Although the alloy may fail at 400° C. after an extended period of time, the Vickers hardness of 100 at 200 hours of heating a 400° C. is very notable. When aged at 300° C. or 350° C., the hardness initially decreased, and then increased over time (FIG. 14A). While aging at 240° C. initially reduced hardness, the hardness increased again with subsequent aging (FIG. 14B) with a faster increase in hardness at 350° C. compared to the as-printed alloy. The data shows that objects fabricated with embodiments of the disclosed alloys are suitable for extended use in high-temperature environments up to 350° C. The high zirconium content of the disclosed alloys increases strength of the additively printed alloys.

Generally, for structural alloys, increased strength and ductility or toughness can be mutually exclusive. However, in some embodiments, the disclosed additively manufactured ACMZ alloys exhibit both increased strength and ductility compared to similar cast ACMZ alloys.

In view of the many possible embodiments to which the principles of the present disclosure may be applied, it should be recognized that the illustrated embodiments are only preferred examples and should not be taken as limiting the scope of the present disclosure. Rather, the scope is defined by the following claims. We therefore claim as our invention all that comes within the scope and spirit of these claims.

We claim:

1. An additively manufactured alloy, comprising:
5 wt % to 35 wt % copper;
0.05 wt % to 3 wt % manganese;
0.5 wt % to 5 wt % zirconium;
0 wt % to 3 wt % iron;
0 wt % to less than 1 wt % silicon; and
aluminum, wherein additively manufactured alloy:
(i) has an ultimate tensile strength of at least 250 MPa throughout a temperature range of 25° C. to 200° C.; or
(ii) has a yield strength of at least 200 MPa throughout a temperature range of 25° C. to 200° C.; or
(iii) exhibits an elongation of at least 10% throughout a temperature range of 25° C. to 250° C.; or
(iv) exhibits an elongation of at least 20% throughout a temperature range of 200° C. to 300° C.; or
(v) any combination of (i), (ii), (iii), and (iv).

2. The additively manufactured alloy of claim 1, comprising:
(i) a microstructure comprising θ′ intermetallic precipitates having an average diameter of 0.1 μm to 0.3 μm; or
(ii) a microstructure comprising θ intermetallic particles having particle spacing of 50-500 nm with a volume fraction of 0-50%; or
(iii) both (i) and (ii).

3. The additively manufactured alloy of claim 1, comprising a microstructure comprising a bimodal distribution of equiaxed grains and columnar grains having an average length-to-width aspect ratio greater than 3.

4. The additively manufactured alloy of claim 1, comprising an Al₃Zr intermetallic phase.

5. The additively manufactured alloy of claim 1, comprising:
8 wt % to 15 wt % copper;
0.3 wt % to 0.6 wt % manganese; and
0.55 wt % to 2 wt % zirconium.

6. The additively manufactured alloy of claim 1, comprising:
8 wt % to 12 wt % copper;
0.4 wt % to 0.5 wt % manganese; and
0.7 wt % to 1.5 wt % zirconium.

7. The additively manufactured alloy of claim 1, comprising:
8 wt % to 15 wt % copper;
0.4 wt % to 0.5 wt % manganese;
0.7 wt % to 1.5 wt % zirconium;
0 wt % to less than 0.1 wt % iron;
0 wt % to less than 0.1 wt % silicon; and
aluminum.

8. The additively manufactured alloy of claim 1, comprising:
8 wt % to 12 wt % copper;
0.4 wt % to 0.5 wt % manganese;
0.8 wt % to 1.2 wt % zirconium;
0 wt % to less than 0.1 wt % iron;
0 wt % to less than 0.1 wt % silicon; and
aluminum.

9. The additively manufactured alloy of claim 1, consisting essentially of:
8 wt % to 15 wt % copper;
0.4 wt % to 0.5 wt % manganese;
0.7 wt % to 1.5 wt % zirconium;
0 wt % to less than 0.1 wt % iron;
0 wt % to less than 0.1 wt % silicon; and
aluminum.

10. The additively manufactured alloy of claim 1, consisting of:
8 wt % to 15 wt % copper;
0.4 wt % to 0.5 wt % manganese;
0.7 wt % to 1.5 wt % zirconium;
0 wt % to less than 0.1 wt % iron;
0 wt % to less than 0.1 wt % silicon;
0 wt % to 0.2 wt % tin; and
aluminum.

11. A fabricated object, comprising the additively manufactured alloy of claim 1.

12. An alloy for additive manufacturing, comprising:
5 wt % to 35 wt % copper;
0.05 wt % to 3 wt % manganese;
greater than 0.5 wt % to 5 wt % zirconium;
0 wt % to 3 wt % iron;
0 wt % to less than 1 wt % silicon; and
aluminum.

13. An alloy feedstock for additive manufacturing, comprising a powder comprising particles having an average particle size of 10 μm to 150 μm, the particles comprising:
5 wt % to 35 wt % copper;
0.05 wt % to 3.0 wt % manganese;
0.5 wt % to 5.0 wt % zirconium;
0 wt % to 3 wt % iron;
0 wt % to less than 1 wt % silicon; and
aluminum.

14. The alloy feedstock of claim 13, wherein the particles comprise:
8 wt % to 15 wt % copper;
0.3 wt % to 0.6 wt % manganese; and
0.55 wt % to 2 wt % zirconium.

15. The alloy feedstock of claim 13, wherein the particles comprise:
8 wt % to 15 wt % copper;
0.4 wt % to 0.5 wt % manganese;
0.7 wt % to 1.5 wt % zirconium;
0 wt % to less than 0.1 wt % iron;
0 wt % to less than 0.1 wt % silicon; and
aluminum.

16. The alloy feedstock of claim 13, wherein the particles comprise:
8 wt % to 12 wt % copper;
0.4 wt % to 0.5 wt % manganese;
0.8 wt % to 1.2 wt % zirconium;
0 wt % to less than 0.1 wt % iron;
0 wt % to less than 0.1 wt % silicon; and
aluminum.

17. A method, comprising:
(a) adding a first amount of the alloy feedstock of claim 13 to a build platform;
(b) exposing the first amount, or a portion thereof, of the alloy feedstock to an energy source to provide a first energy-treated region on the build platform;
(c) adding a second amount of the alloy feedstock to the build platform, wherein the second amount of the alloy feedstock is positioned immediately adjacent to the first energy-treated region on the build platform;
(d) exposing the second amount, or a portion thereof, of the alloy feedstock to the energy source to provide a second energy-treated region on the build platform; and
repeating one or more of steps (a), (b), (c), and (d) to fabricate an object.

18. The method of claim 17, wherein the energy source is a laser.

19. The method of claim 18, wherein exposing to the energy source comprises performing a skip raster scan pattern with the laser.

20. The method of claim 17, further comprising preheating the build platform to a temperature of 150° C. to 250° C. prior to one or more of steps (a), (b), (c), and (d).
